(19) United States
(12) Patent Application Publication
(10) Pub. No.: US 2025/0051945 A1
(43) Pub. Date: Feb. 13, 2025

(54) BUILT-IN ELECTROLYZER FOR INCREASING DURABILITY OF A FLOW BATTER BY REBALANCING THE ELECTROLYTE COMPOSITION

(71) Applicant: LAWRENCE LIVERMORE NATIONAL SECURITY, LLC, Livermore, CA (US)

(72) Inventors: Buddhini Srimali Jayathilake, Tracy, CA (US); Marissa Wood, Oakland, CA (US); James Spencer Oakdale, Castro Valley, CA (US); Anna Nikolaevna Ivanovskaya, Mountain View, CA (US)

(21) Appl. No.: 18/447,876

(22) Filed: Aug. 10, 2023

(51) Int. Cl. C25B 15/08; C25B 9/19; H01M 8/06; H01M 8/18

(52) U.S. Cl. CPC C25B 15/087; C25B 9/19; H01M 8/0693; H01M 8/188

(57) ABSTRACT

Durability of an energy conversion and storage system is increased by rebalancing the electrolyte composition used in the system. The storage system includes a main device, a sub device, an electrolyte, and a device for directing the electrolyte from the main device to the sub device. The system has re-balancing capacity for the electrolyte properties of the electrolyte in the sub device. The as re-balancing capacity includes rebalancing pH of the electrolyte and/or rebalancing conductivity of the electrolyte and/or rebalancing solubility of the electrolyte.

### AND STATEMENT AS TO RIGHTS TO APPLICATIONS MADE UNDER AND FEDERALLY SPONSORED RESEARCH DEVELOPMENT

This invention was made with Government support under Contract No. DE-AC52-07NA27344 awarded by the United States Department of Energy. The Government has certain rights in the invention.

### BACKGROUND

### Field of Endeavor

The present application relates to flow batteries and more particularly to a flow battery with an electrolyzer.

### State of Technology

This section provides background information related to the present disclosure which is not necessarily prior art.

Iron is the most abundant transition metal in the earth's crust and is a promising candidate for low cost and scalable grid storage systems. The major issue hampering the practical implementation of iron redox flow battery is that the hydrogen evolution reaction at the plating electrode acts as a parasitic competing pathway and offsets coulombic efficiency (CE).

The state-of-the-art solution for lessening the effects of hydrogen evolution entails incorporation of Pt-catalyzed H₂ and iron (III) in a recombination fuel cell. This recombination fuel cell converts evolved H₂ gas in the flow battery to protons while recovering the power lost due to parasitic reaction. Despite these advances, this method is cumbersome (due to gas phase reactions requiring means for gas capture and delivery) and does not sufficiently improve the durability required for long duration energy storage systems. Recent literature shows that there is still unacceptable level of capacity loss (50% loss in 100 cycles) due in large part to poor recoverability of H₂.

The inventor's apparatus, system, and method addresses durability issue of flow battery by employing a built-in rebalancing electrolyzer instead of the state-of-the-art recombination fuel cell. Even though the rebalancing electrolyzer requires a small input of energy, it is an all-liquid reactor (does not require H₂ gas capture/delivery) and therefore it is simpler compared to the cumbersome recombination fuel cell. This rebalancing electrolyzer allows to more effectively restore the capacity, pH and electrolyte composition of the iron flow battery compared to the state-of-the-art method. Therefore, it is better suited for achieving the durability, cyclability and robustness of the iron flow battery required for commercial deployment.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

The durability of an energy conversion and storage system is increased by rebalancing the electrolyte composition used in the system. The storage system includes a main device, a sub device, an electrolyte, and a device for directing the electrolyte from the main device to the sub device. The system has re-balancing capacity for the electrolyte properties of the electrolyte in the sub device. The as re-balancing capacity includes rebalancing pH of the electrolyte and/or rebalancing conductivity of the electrolyte and/or rebalancing solubility of the electrolyte.

Applicant's energy conversion and storage system for increasing durability by rebalancing an electrolyte composition includes an aqueous redox flow battery or an electrolyzer or a stationary electrochemical energy storage system or other similar device; a semi-electrolyzer subunit; electrolyte; a cathode in the semi-electrolyzer subunit; an anode a cathode in the semi-electrolyzer subunit; a circulation system connected to the aqueous redox flow battery redox flow battery or the electrolyzer or the stationary electrochemical energy storage system or the other similar device and to the semi-electrolyzer subunit wherein the electrolyte is circulated and rebalanced.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 is a flow chart that illustrates an embodiment of Applicant's method of increasing durability of an energy conversion and storage system by rebalancing the electrolyte composition.

FIG. 2 is an illustrative view showing an embodiment of Applicant's apparatus, systems, and methods.

FIG. 3 is an illustrative view showing an embodiment of Applicant' subunit.

FIG. 4 is an illustrative view showing another embodiment of Applicant's apparatus, systems, and methods.

FIG. 5 is an illustrative view showing another embodiment of Applicant' sub-unit.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

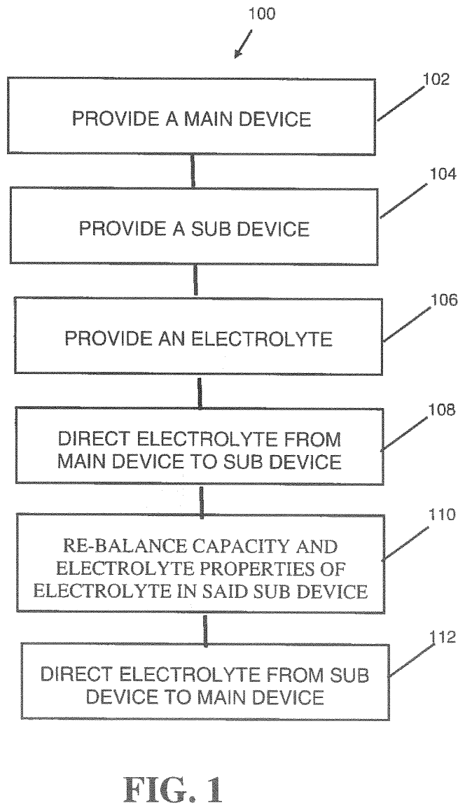

Referring now to FIG. 1, a flow chart illustrates an embodiment of Applicant's method of increasing durability of an energy conversion and storage system by rebalancing the electrolyte composition. This embodiment is identified generally by the reference numeral 100. The steps of Applicant's method embodiment 100 illustrated in FIG. 1 are listed below:
Reference Numeral No. 102—provide a main device,
Reference Numeral No. 104—provide a sub device,
Reference Numeral No. 106—provide an electrolyte,
Reference Numeral No. 108—directing the electrolyte from the main device to the sub device,
Reference Numeral No. 110—re-balance the capacity and electrolyte properties of the electrolyte in the sub device, and
Reference Numeral No. 112—direct the electrolyte from the sub device to the main device.

The identification and description of the steps of the Applicant's method embodiment 100 having been completed, the operation and additional description of the Applicant's method embodiment 100 will now be considered in greater detail. Applicant's method embodiment 100 includes the step 102 of providing a main device. Step 102 is providing a sub device. An electrolyte is provided in step 106. Step 108 is directing electrolyte from the main device to a sub device. Step 110 is re-balance capacity and electrolyte properties of electrolyte in said sub device. In step 112 the electrolyte is directed from the sub device to the main device.

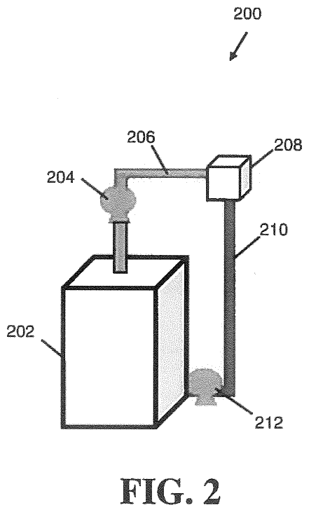

Referring now to FIG. 2, an illustrative view shows another embodiment of Applicant's apparatus, systems, and methods. This embodiment is identified generally by the reference numeral 200. The components of Applicant's apparatus, systems, and methods embodiment 200 illustrated in FIG. 2 are listed below:
Reference Numeral No. 202—main device,
Reference Numeral No. 204—1^{st} pump,
Reference Numeral No. 206—electrolyte,
Reference Numeral No. 208—sub-device,
Reference Numeral No. 210—electrolyte, and
Reference Numeral No. 212—2^{nd} pump.

The description of the components of the Applicant's apparatus, systems, and methods embodiment 200 having been completed, the operation and additional description of the Applicant's apparatus, systems, and methods embodiment 200 will now be considered in greater detail.

The main device 202 can be an aqueous redox flow battery, an electrolyzer, a stationary electrochemical energy storage system, or other similar device. As illustrated in FIG. 2 the main device 202 could be an aqueous redox flow battery, electrolyzer or a stationary electrochemical energy storage system. The size of the sub device could be about 5% of the size of the main device. Purpose of having a sub device is to restore electrolyte properties including pH, conductivity, and capacity across the main device.

The main device 202 is an apparatus for increasing durability of an energy conversion and storage system by rebalancing the electrolyte composition. It includes an aqueous redox flow battery or an electrolyzer or a stationary electrochemical energy storage system or other similar device 202; a semi-electrolyzer subunit 208; an electrolyte 206; a cathode in the semi-electrolyzer subunit; an anode a cathode in said semi-electrolyzer subunit; a circulation system connected to said aqueous redox flow battery redox flow battery or said electrolyzer or said stationary electrochemical energy storage system or said other similar device and to said semi-electrolyzer subunit wherein said electrolyte is circulated and rebalanced.

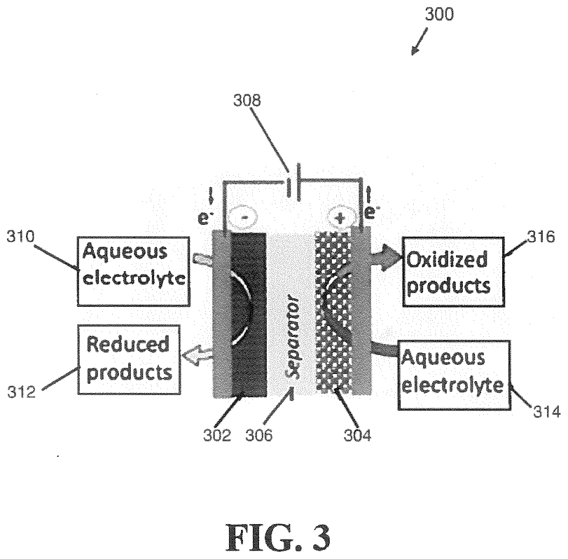

Referring now to FIG. 3, an illustrative view shows the inventor's built-in semi-electrolyzer which enables re-balancing the capacity & electrolyte properties such as pH, conductivity, solubility in energy conversion & storage systems. This improves durability of aqueous electrochemical systems by directly counteracting both short and long-term issues associated with side reactions (e.g., effects of hydrogen evolution). The method particularly advantageous for low-cost iron flow battery which is not yet widely deployed due to limited durability. The components of Applicant's apparatus, systems, and methods embodiment 300 illustrated in FIG. 3 are listed below:
Reference Numeral No. 302—cathode,
Reference Numeral No. 304—anode,
Reference Numeral No. 306—separator,
Reference Numeral No. 308—power supply,
Reference Numeral No. 310—first aqueous electrolyte,
Reference Numeral No. 312—reduced products,
Reference Numeral No. 314—second aqueous electrolyte, and
Reference Numeral No. 316—oxidized products.

The description of the components of the Applicant's apparatus, systems, and methods embodiment 300 having been completed, the operation and additional description of the Applicant's apparatus, systems, and methods embodiment 300 will now be considered in greater detail.

As illustrated in FIG. 3 the sub device 300 has three major physical components:
1. cathode electrode 302 to achieve reduction half-cell reactions,
2. anode 304 electrode to achieve oxidation half-cell reactions and
3. separator 306 to prevent mixing of chemical components (electrolytes from both sides) but to facilitate selective ion exchange.

In the main device, the electrolytes 310 and 314 could be ion conductive aqueous solution acidic, neutral, or alkaline conditions. They are stored in external tanks or within the storage system. If they are stored externally, they can be circulated through the main device using external pumps to achieve electrochemical reactions at the electrode interfaces. The same electrolytes circulated through the main device can be circulated through one side of the subunit cell. Water or another aqueous media electrolyte could be circulated through the other half of the subunit. Cathode materials are the state-of-the-art porous, high surface area carbon electrodes. Porous, high surface area stable water oxidation catalysts are used as anode materials in the sub device. Separators 306 could be ion selective membranes or porous separators; they could be selected based on pH conditions and selective ion transport requirements.

To achieve electrochemical reactions at the subunit 300, external power 308 may be needed to supply. When the electrochemical circuit is completed in the sub device, it can electrochemically convert the excess charge back to the original oxidation state while generating protons or hydroxide ions at the opposite electrode to balance the pH of the electrolyte. Reaction products 312 and 314 at both electrodes enable restoring the conductivity of the electrolyte. The operation of the sub device could be designed and programmed based on the efficiency and rebalancing requirements. In some cases, the operation of the sub device can be done continuously in parallel to the operation of the main device. In other cases, operation of the sub device can be done at intervals.

The special application of the sub device the inventors have developed is for a rebalancing unit for iron based redox flow battery. The major issue hampering the practical implementation of iron redox flow battery is that the hydrogen evolution reaction at the plating electrode acts as a parasitic competing pathway and causes poor coulombic efficiency (CE). While 98% CE is achievable by engineering the electrolyte and operation conditions, the remaining inefficiencies due to the hydrogen evolution can significantly constrain the rechargeability of the battery through pH elevation, hydroxide precipitation, and capacity imbalance; all of which lead to rapid performance degradation. The state-of-the-art solution for lessening the effects of hydrogen evolution entails incorporation of Pt catalyzed H2 and iron (III) in a recombination fuel cell.

Despite these advances, there is still an unacceptable level of capacity loss (50% loss in 100 cycles) due in large part to poor recoverability of H₂. Compared to currently available rebalancing technologies, our technology can electrochemically restore the full capacity of and pH of the iron flow battery with <1% energy efficiency sacrifice and meet DOE's demands for low-cost alternatives for long duration energy storage.

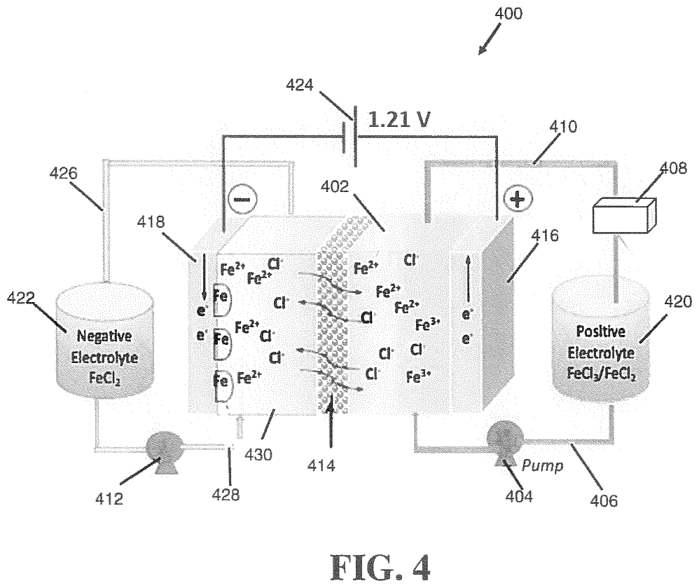

Referring now to FIG. 4, an illustrative view shows another embodiment of Applicant's apparatus, systems, and methods. This embodiment is identified generally by the reference numeral 400. The components of Applicant's apparatus, systems, and methods embodiment 400 illustrated in FIG. 4 are listed below:
Reference Numeral No. 402—positive electrolyte,
Reference Numeral No. 404—1^{st} pump,
Reference Numeral No. 406—electrolyte,
Reference Numeral No. 408—sub-device,
Reference Numeral No. 410—electrolyte,
Reference Numeral No. 412—2^{nd} pump,
Reference Numeral No. 414—separator,
Reference Numeral No. 416—anode,
Reference Numeral No. 418—cathode,
Reference Numeral No. 420—positive electrolyte,
Reference Numeral No. 422—negative electrolyte,
Reference Numeral No. 424—power source,
Reference Numeral No. 426—fluid line,
Reference Numeral No. 428—fluid line, and
Reference Numeral No. 430—negative electrolyte.

The description of the components of the Applicant's apparatus, systems, and methods embodiment 400 having been completed, the operation and additional description of the Applicant's apparatus, systems, and methods embodiment 400 will now be considered in greater detail.

The main device can be an aqueous redox flow battery, an electrolyzer, a stationary electrochemical energy storage system, or other similar device. The main device is an apparatus for increasing durability of an energy conversion and storage system by rebalancing the electrolyte composition. It includes an aqueous redox flow battery or an electrolyzer or a stationary electrochemical energy storage system or other similar device; a semi-electrolyzer subunit; an electrolyte; a cathode in the semi-electrolyzer subunit; an anode a cathode in said semi-electrolyzer subunit; a circulation system connected to said aqueous redox flow battery redox flow battery or said electrolyzer or said stationary electrochemical energy storage system or said other similar device and to said semi-electrolyzer subunit wherein said electrolyte is circulated and rebalanced.

As illustrated in FIG. 4, the electrolytes 406 and 410 could be ion conductive aqueous solution acidic, neutral, or alkaline conditions. They can be stored in external tanks or within the storage system. If they are stored externally, they can be circulated through the main device using external pumps 404 and 412 to achieve electrochemical reactions at the electrode interfaces. The same electrolytes circulated through the main device can be circulated through one side of the subunit cell. Water or another aqueous media electrolyte could be circulated through the other half of the subunit. Cathode materials are the state-of-the-art porous, high surface area carbon electrodes. Porous, high surface area stable water oxidation catalysts are used as anode materials in the sub device. Separators could be ion selective membranes or porous separators; they could be selected based on pH conditions and selective ion transport requirements.

To achieve electrochemical reactions at the subunit 408, external power 424 may be needed to be supplied. When the electrochemical circuit is completed in the sub device, it can electrochemically convert the excess charge back to the original oxidation state while generating protons or hydroxide ions at the opposite electrode to balance the pH of the electrolyte. Reaction products 402 and 430 at both electrodes 416 and 418 enable restoring the conductivity of the electrolyte. The operation of the sub device could be designed and programmed based on the efficiency and rebalancing requirements. In some cases, the operation of the sub device can be done continuously in parallel to the operation of the main device. In other cases, operation of the sub device can be done at intervals.

The special application of the sub device the inventors have developed is for a rebalancing unit for iron based redox flow battery. The major issue hampering the practical implementation of iron redox flow battery is that the hydrogen evolution reaction at the plating electrode acts as a parasitic competing pathway and causes poor coulombic efficiency (CE). The state-of-the-art solution for lessening the effects of hydrogen evolution entails incorporation of Pt catalyzed H2 and iron (III) in a recombination fuel cell.

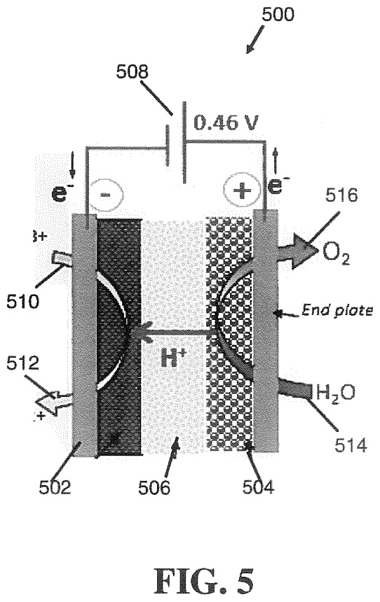

Referring now to FIG. 5, an illustrative view shows another embodiment of the inventor's built-in semi-electrolyzer which enables re-balancing the capacity & electrolyte properties such as pH, conductivity, solubility in energy conversion & storage systems. This improves durability of aqueous electrochemical systems by directly counteracting both short and long-term issues associated with side reactions (e.g., effects of hydrogen evolution). The method particularly advantageous for low-cost iron flow battery which is not yet widely deployed due to limited durability. The components of Applicant's apparatus, systems, and methods embodiment 500 illustrated in FIG. 5 are listed below:
Reference Numeral No. 502—cathode,
Reference Numeral No. 504—anode,
Reference Numeral No. 506—separator,
Reference Numeral No. 508—power supply,
Reference Numeral No. 510—first aqueous electrolyte,
Reference Numeral No. 512—reduced products,
Reference Numeral No. 514—second aqueous electrolyte, and
Reference Numeral No. 516—oxidized products.

The description of the components of the Applicant's apparatus, systems, and methods embodiment 500 having been completed, the operation and additional description of the Applicant's apparatus, systems, and methods embodiment 500 will now be considered in greater detail.

As illustrated in FIG. 5 the sub device 500 has three major physical components:
1. cathode electrode 502 to achieve reduction half-cell reactions,
2. anode 504 electrode to achieve oxidation half-cell reactions and
3. separator 506 to prevent mixing of chemical components (electrolytes from both sides) but to facilitate selective ion exchange.

In the main device, the electrolytes 510 and 514 could be ion conductive aqueous solution acidic, neutral, or alkaline conditions. They are stored in external tanks or within the storage system. If they are stored externally, they can be circulated through the main device using external pumps to achieve electrochemical reactions at the electrode interfaces. The same electrolytes circulated through the main device can be circulated through one side of the subunit cell. Water or another aqueous media electrolyte could be circulated through the other half of the subunit. Cathode materials are the state-of-the-art porous, high surface area carbon electrodes. Porous, high surface area stable water oxidation catalysts are used as anode materials in the sub device. Separators 506 could be ion selective membranes or porous separators; they could be selected based on pH conditions and selective ion transport requirements.

To achieve electrochemical reactions at the subunit 500, external power 508 may be needed to supply. When the electrochemical circuit is completed in the sub device, it can electrochemically convert the excess charge back to the original oxidation state while generating protons or hydroxide ions at the opposite electrode to balance the pH of the electrolyte. Reaction products 512 and 514 at both electrodes enable restoring the conductivity of the electrolyte. The operation of the sub device could be designed and programmed based on the efficiency and rebalancing requirements. In some cases, the operation of the sub device can be done continuously in parallel to the operation of the main device. In other cases, operation of the sub device can be done at intervals.

The special application of the sub device the inventors have developed is for a rebalancing unit for iron based redox flow battery. The major issue hampering the practical implementation of iron redox flow battery is that the hydrogen evolution reaction at the plating electrode acts as a parasitic competing pathway and causes poor coulombic efficiency (CE). While 98% CE is achievable by engineering the electrolyte and operation conditions, the remaining inefficiencies due to the hydrogen evolution can significantly constrain the rechargeability of the battery through pH elevation, hydroxide precipitation, and capacity imbalance; all of which lead to rapid performance degradation. 1 The state-of-the-art solution for lessening the effects of hydrogen evolution entails incorporation of Pt catalyzed H2 and iron (III) in a recombination fuel cell.

Despite these advances, there is still an unacceptable level of capacity loss (50% loss in 100 cycles) due in large part to poor recoverability of H₂. Compared to currently available rebalancing technologies, our technology can electrochemically restore the full capacity of and pH of the iron flow battery with <1% energy efficiency sacrifice and meet DOE's demands for low-cost alternatives for long duration energy storage.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. An energy conversion and storage system apparatus for increasing durability by rebalancing an electrolyte composition, comprising:
an aqueous redox flow battery or an electrolyzer or a stationary electrochemical energy storage system or other similar device;
a semi-electrolyzer subunit;
electrolyte;
a cathode in said semi-electrolyzer subunit;
an anode a cathode in said semi-electrolyzer subunit;
a circulation system connected to said aqueous redox flow battery redox flow battery or said electrolyzer or said stationary electrochemical energy storage system or said other similar device and to said semi-electrolyzer subunit wherein said electrolyte is circulated and rebalanced.

2. The apparatus of claim 1 wherein said aqueous redox flow battery or electrolyzer or stationary electrochemical energy storage system or other similar device is an aqueous redox flow battery.

3. The apparatus of claim 1 wherein said aqueous redox flow battery or electrolyzer or stationary electrochemical energy storage system or other similar device is an electrolyzer.

4. The apparatus of claim 1 wherein said circulation system comprises means for re-balancing capacity and electrolyte properties of said electrolyte.

5. The apparatus of claim 1 wherein said circulation system comprises means for rebalancing pH of said electrolyte.

6. The apparatus of claim 1 wherein said circulation system comprises means for rebalancing conductivity of said electrolyte.

7. The apparatus of claim 1 wherein said circulation system comprises means for rebalancing solubility of said electrolyte.

8. The apparatus of claim 1 wherein said semi-electrolyzer subunit includes
a cathode,
an anode,
a separator between said cathode and said anode, and
a power supply connected to said cathode and said anode.

9. The apparatus of claim 1 wherein said semi-electrolyzer subunit includes
a first aqueous electrolyte,
reduced products,
a second aqueous electrolyte, and
oxidized products.

10. The apparatus of claim 1 wherein said aqueous redox flow battery or an electrolyzer or a stationary electrochemical energy storage system has a size, wherein said semi-electrolyzer subunit has a size, and wherein said semi-electrolyzer subunit size is less than ten percent of said size of said electrolyzer or a stationary electrochemical energy storage system.

11. The apparatus of claim 1 wherein said aqueous redox flow battery or an electrolyzer or a stationary electrochemical energy storage system has a size, wherein said semi-electrolyzer subunit has a size, and wherein said semi-electrolyzer subunit size is less than five percent of said size of said electrolyzer or a stationary electrochemical energy storage system.

12. An apparatus for increasing durability of an energy conversion and storage system by rebalancing the electrolyte composition, comprising:
a cathode,
an anode,
a separator between said cathode and said anode, and
a power supply connected to said cathode and said anode.

13. The apparatus of claim 12 further comprising
a first aqueous electrolyte,
reduced products,
a second aqueous electrolyte, and
oxidized products.

14. A method of increasing durability of an energy conversion and storage system by rebalancing the electrolyte composition, comprising the steps of:
providing a main device,
providing a sub device,
providing an electrolyte,
directing said electrolyte from said main device to said sub device,
re-balancing capacity and electrolyte properties of said electrolyte in said sub device, and
directing said electrolyte from said sub device to said main device.

15. The method of increasing durability of an energy conversion and storage system by rebalancing the electrolyte composition of claim 14 wherein said step of re-balancing capacity and electrolyte properties of said electrolyte in said sub device comprises the step of rebalancing pH of said electrolyte.

16. The method of increasing durability of an energy conversion and storage system by rebalancing the electrolyte composition of claim 14 wherein said step of re-balancing capacity and electrolyte properties of said electrolyte in said sub device comprises the step of rebalancing conductivity of said electrolyte.

17. The method of increasing durability of an energy conversion and storage system by rebalancing the electrolyte composition of claim 14 wherein said step of re-balancing capacity and electrolyte properties of said electrolyte in said sub device comprises the step of rebalancing solubility of said electrolyte.
